(19) United States
(12) Patent Application Publication
(10) Pub. No.: US 2010/0140985 A1
(43) Pub. Date: Jun. 10, 2010

(54) BACKREST WITH HEADREST SLEEVE FOR ATTACHING A COMPONENT

(75) Inventors: Darlo Pehar, Leverkusen (DE); Joerg Haubrich, Leverkusen (DE)

Correspondence Address: Johnson Controls, Inc.;c/o Fletcher Yoder PC, P.O. Box 692289, Houston, TX, 77269, US

(73) Assignee: Johnson Control Technology Company, Holland, MI (US)

(21) Appl. No.: 12/447,882

(22) PCT Filed: Oct. 26, 2007
(86) PCT No.: PCT/EP07/09319

§ 371 Date: Feb. 3, 2010

(30) Foreign Application Priority Data
Nov. 7, 2006 (DE) 10 2006 052 703.8

(51) Int. Cl. A47C 7/62; B60N 2/58; B60N 2/68; B68G 7/00

(52) U.S. Cl. 297/188.06; 29/91.1

(57) ABSTRACT

A backrest for a vehicle seat is disclosed. The backrest has a support fastened to a back plate and at least one sleeve fastened to the support. A foam material and a fabric are placed around the support, the fabric having at least one cutout. An insertion sleeve of a component is pulled through the cutout and over a lower end of the headrest sleeve. The component, such as a screen, is fastened at an end to the backplate and/or to the support.

### CROSS REFERENCE TO RELATED APPLICATIONS

This application claims priority from and the benefit of PCT Application No. PCT/EP2007/009319, filed on Oct. 26, 2007; and German Patent No. DE 10 2006 052 703.8, filed on Nov. 7, 2006; both entitled “Backrest with Headrest Sleeve for Attaching a Component”, which are herein incorporated by reference.

### BACKGROUND

The invention relates to a backrest for a vehicle seat with a headrest fastening, wherein the headrest fastening has at least one headrest sleeve with an upper end and a lower end. Furthermore, a method for producing a backrest with a headrest fastening is proposed.

Such devices and methods are known in general. The publication FR 2 837 151 describes, for example, a backrest for a vehicle with two tubes via which a reinforcing component for the backrest is attached. However, the complicated construction of the backrest and the high outlay on installation if an additional component is to be fastened to the backrest are disadvantages of said backrest.

It was the object of the present invention to specify a backrest and a method for producing the backrest, said backrest not having the disadvantages of the backrests known from the prior art and nevertheless being uncomplicated to produce and having few components.

### SUMMARY

The invention is achieved by means of a backrest for a vehicle seat with a headrest fastening, wherein the headrest fastening has at least one headrest sleeve with an upper end and a lower end, wherein a headrest is provided in a manner such that it can be attached to the upper end of the headrest sleeve, and a component can be attached to the lower end.

It is advantageously possible by means of the invention to fasten a further component, in addition to a headrest, to the backrest without a further fastening device having to be provided for this. By attachment of the component to the lower end of the headrest sleeve, neither is the functioning of the headrest impeded nor does the installation of the headrest have to be changed. In addition, the component can be installed over a foam cover and a fabric, and therefore the component can be exchanged, even after the backrest is completed, without damaging the upholstery or the cover or the fabric.

A support preferably contains the headrest sleeve. The support is preferably connected to a back plate, with the connection being produced, for example, by means of welding. The headrest sleeve is likewise preferably welded to the support. The support is preferably a supporting structure of the backrest. It is also conceivable that the support is not connected to a back plate but rather the support is only required for the backrest. Furthermore, it is conceivable that the headrest sleeve is connected to the back plate and no support is required for the backrest.

The component is preferably a screen and has at least one insertion sleeve. The screen is manufactured, for example, from plastic, with the insertion sleeve preferably being formed as a single piece with the screen. As a single piece is to be understood here as meaning that the screen and the insertion sleeve are produced as one component during the manufacturing. The number of insertion sleeves preferably equals the number of headrest sleeves.

At least one of the insertion sleeves of the component can furthermore preferably be connected to the lower end of the headrest sleeve in a frictional and/or interlocking manner. By this means, the component can be connected in an advantageous manner to the lower end of the headrest sleeve without additional fastening means, such as adhesives or weld seams, being required.

The insertion sleeve of the component preferably has a diameter which is larger than the diameter of the headrest sleeve. The insertion sleeve can thus be pulled over the lower end of the headrest sleeve or the headrest sleeve can be inserted into the insertion sleeve. In this case, an interlocking and frictional connection between the component and the headrest sleeve can be achieved in a particularly uncomplicated manner. In particular, the installation time is substantially shortened because of the uncomplicated rapid installation.

It is furthermore preferred that the component is fastened at a second end to a back plate and/or to the support of a backrest. The fastening here preferably takes place by means of a clip connection between the component and back plate or support. The component is consequently fastened between the headrest sleeve and the back plate or the support and is therefore secured against horizontal and vertical displacement. Nevertheless, the component can be easily released by the clip connection being released from the back plate or the support and the insertion sleeve being pulled from the headrest sleeve. The fastening of the component is therefore reversible. However, irreversible connections between the component and back plate or support, such as, for example, an adhesively bonded seam, are also conceivable.

The component is particularly preferably suitable for accommodating an armrest. In the case of the backrest according to the invention, an armrest can be connected to the component after the backrest is produced. The armrest here is preferably connected pivotably to the component, and can be transferred from a horizontal use position into a vertical not-in-use position and vice versa. In the not-in-use position, the armrest preferably ends flush with the backrest and is preferably usable as a backrest. However, it is also conceivable that the component acts only as a screen or as a means of protecting from view when an armrest is swung into the use position. In this case, the armrest is fastened, for example, to the support of the backrest. If the armrest is now swung, for use, in the direction of the seat part, the component is visible.

The present invention furthermore relates to a method for producing a backrest with a headrest fastening. In the method, a support is fastened to a back plate, wherein at least one headrest sleeve is fastened to the support. A foam material, for example foam, is placed over the support. The thickness of the foam material is selected here in such a manner that the support located therebelow can essentially no longer be felt by an occupant leaning against the backrest. It is also conceivable that the foam material is not only placed over the support but also onto the back plate. In a next method step, a fabric is fastened over the support such that the foam material is no longer visible to an occupant. The fabric, also referred to as a cover, can be stretched both over the support and over the back plate. In order to fasten the component, the fabric has at least one cutout in the region of the headrest sleeve. The cutout has either already been taken into consideration during the manufacturing or can be introduced retrospectively into the fabric, for example by trimming the fabric. The foam material can be pressed upward in the region of the headrest sleeve such that, even after the foam material is placed on, access to the headrest sleeve is possible. The insertion sleeve of the component is pulled from below over the headrest sleeve through the cutouts in the fabric. For this purpose, the foam material is pressed to the side. The component is subsequently connected at its second end to the back plate and/or to the support. For this purpose, the fabric has, in a lower region, further cutouts through which a connection between the component and back plate or support is possible.

The component is preferably located over the fabric. In this case, the foam material can be located only at the edge of the component or else can be arranged under the component. However, it would also be conceivable for the component to be located below the fabric. In this case, the component would not be visible in a use position of the armrest. In this case too, the foam material can be located only at the edge of the component or can also be present below the component.

### DRAWINGS

The invention is explained below with reference to figures. The figures are equally applicable to the backrest according to the invention and the method for producing the backrest and do not restrict the general inventive concept.

FIG. 1 schematically shows the backrest according to the invention with a headrest fastening.

FIG. 2 schematically illustrates the backrest and a component, with the component being fastened to two headrest sleeves.

FIG. 3 schematically shows the component and a support which has been covered with a foam material and a fabric.

FIG. 4 schematically illustrates the backrest with the component and a headrest.

### DETAILED DESCRIPTION

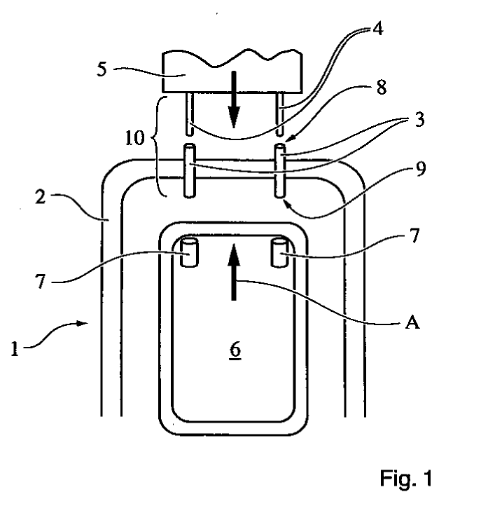

FIG. 1 illustrates the backrest 1 according to the invention, with upholstery of a support 2 with a foam material and a fabric 12 being omitted in the illustration. Two headrest sleeves 3 are attached to a support 2, for example by welding. A headrest 5 has two retaining rods 4 which, together with the headrest sleeves 3, form a headrest fastening 10. In order to fasten the headrest 5 to the backrest 1, the retaining rods 4 are inserted into the upper end 8 of the headrest sleeves 3. An interlocking and/or frictional connection is produced in this case. In the exemplary embodiment, a component 6 has two insertion sleeves 7 which can be pushed from below, i.e. in the direction A, onto the lower ends 9 of the headrest sleeves 3. For this purpose, the insertion sleeves 7 have a diameter which is larger than the diameter of the headrest sleeves 3. It goes without saying that an interlocking and/or frictional connection between the headrest sleeves 3 and the insertion sleeves 7 is also produced if the lower end 9 of the headrest sleeves 3 is inserted into the insertion sleeves 7. After the headrest sleeves 3 are inserted into the insertion sleeves 7, an interlocking and/or frictional connection is produced between the headrest sleeves 3 and insertion sleeves 7. The functioning of the headrest 5 is not impaired by attaching the component 6 to the lower end 9 of the headrest sleeve 3. Additional fastening of the component 6 or of the insertion sleeves 7 to the headrest sleeves 3 is not necessary.

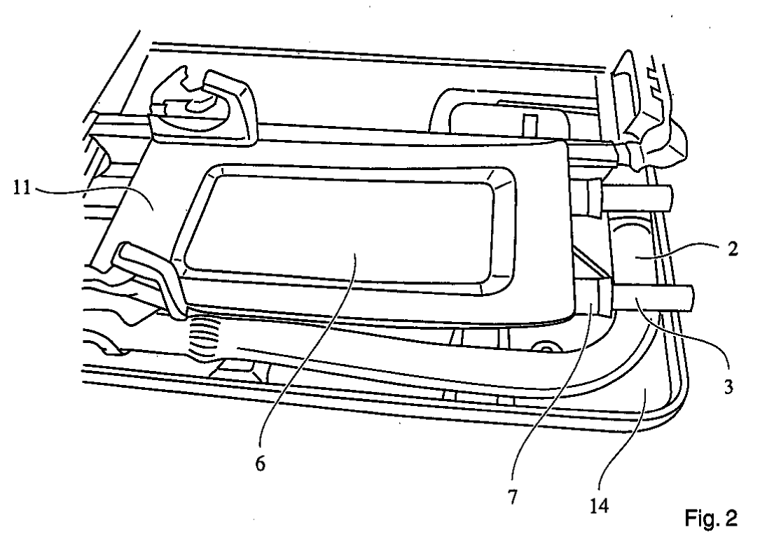

FIG. 2 schematically shows the component 6 in conjunction with the headrest sleeves 3. The connection is produced in this case by the insertion sleeves 7 which have been pulled over the lower ends 9 of the headrest sleeves 3. In this case, the headrest sleeves 3 are fastened to a support 2 which is connected in turn to a back plate 14. After the fastening by means of the insertion sleeves 7, the component 6 is connected at a second end 11 to the support 2 and/or to the back plate 14. This connection can be, for example, a clip connection or a hook connection. However, it is also possible for the component to be screwed and/or firmly riveted to the support and/or to the back plate. For the purpose of providing a better illustration in FIG. 2, a foam support or fabric 12 has not been included in FIG. 2. However, the component 6 is preferably essentially located over the foam material and the fabric 12, as a result of which the component 6 can be reversibly exchanged. In the lower end 11 of the component 6, an armrest can preferably be attached to the component 6. However, it is also conceivable that the armrest is fastened to the support 2 or to the back plate 14 and the component 6 serves merely as a screen or as a means of protecting from view when the armrest is pivoted into the use position. The armrest is preferably attached in such a manner that it can be pivoted from a use position into a not-in-use position and vice versa.

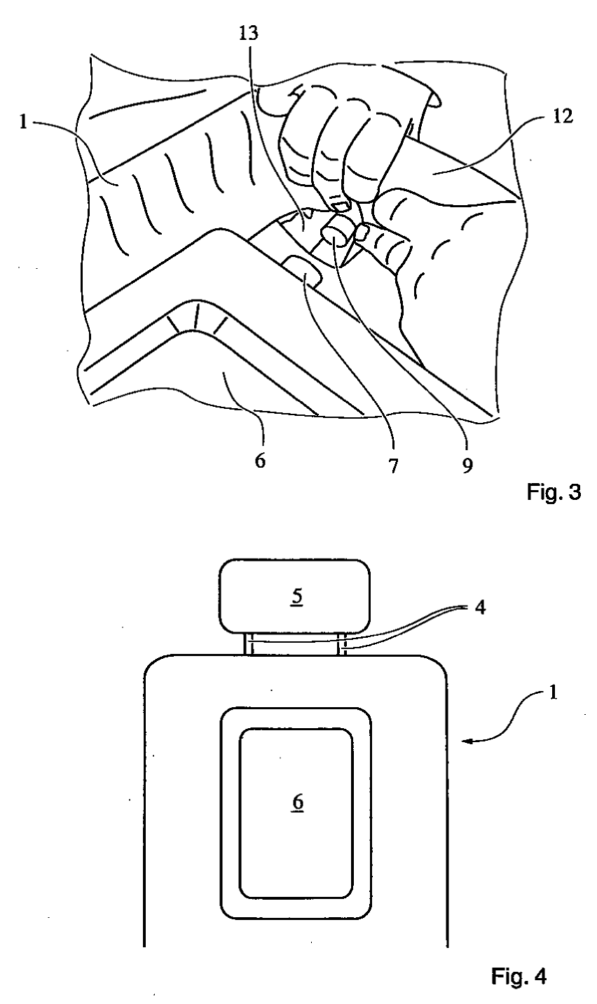

FIG. 3 illustrates the backrest 1 together with the foam material and fabric. In the exemplary embodiment, the foam material is located only around the support 2 (not visible) and is completely concealed by the fabric 12. The fabric 12 here is pulled both over the support 2 and over the back plate 14. For the installation of the component 6 on the backrest 1, the fabric 12 has at least one cutout 13. The cutout 13 has either already been taken into consideration during the manufacturing or has been produced retrospectively by trimming the fabric. In order to be able to pull the insertion sleeve 7 over the lower end 9 of the headrest sleeve, the fabric 12 and the foam material have to be pressed in such a manner that the lower end 9 of the headrest sleeve 3 is exposed. After the lower end 9 of the headrest sleeve 3 is connected to the insertion sleeve 7, and the fabric 12 and the foam material are no longer being pressed, the connection between the two sleeves 3, 7 is no longer visible. It is also conceivable for the foam material to be located over the lower end 9 of the headrest sleeve 3 in such a manner that a cutout also has to be undertaken in the foam material.

FIG. 4 illustrates the vehicle seat with the headrest 5 and the component 6. In this case, the connections with which the component 6 is connected to the support 2 or the back plate 14 and the headrest sleeves 3 are not visible.

1. A backrest for a vehicle seat with a headrest fastening, comprising a headrest fastening having at least one headrest sleeve with an upper end and a lower end, wherein a headrest is provided in a manner such that it can be attached to the upper end of the headrest sleeve, and a component can be attached to the lower end.

2. The backrest as claimed in claim 1, wherein the component has at least one insertion sleeve.

3. The backrest as claimed in claim 1, wherein the component is a screen.

4. The backrest as claimed in claim 1, wherein an insertion sleeve of the component can be connected to the lower end of the headrest sleeve in a frictional and/or interlocking manner.

5. The backrest as claimed in claim l, wherein an insertion sleeve of the component can be pulled over the lower end of the headrest sleeve.

6. The backrest as claimed in claim 1, wherein the component is fastened at a second end thereof to a back plate and/or to a support of a backrest.

7. The backrest as claimed in claim 1, wherein the component is suitable for accommodating an armrest.

8. The backrest as claimed in claim 1, wherein the headrest sleeves are provided on a backrest support.

9. A method for producing a backrest with a headrest fastening, wherein a support is fastened to a back plate and at least one headrest sleeve is fastened to the support, comprising placing a foam material and a fabric around the support, the fabric having at least one cutout, pulling an insertion sleeve of a component from below through the cutout in the fabric and over a lower end of the headrest sleeve, and fastening the component at a second end to the back plate and/or to the support.
